(19) United States
(12) Patent Application Publication
(10) Pub. No.: US 2009/0047092 A1
(43) Pub. Date: Feb. 19, 2009

(54) COATED FASTENERS

(75) Inventor: Robin M. Peffer, Valencia, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/839,181

(22) Filed: Aug. 15, 2007

(51) Int. Cl. F16B 39/00; F16B 15/08

(52) U.S. Cl. 411/257; 411/442; 411/81

(57) ABSTRACT

Disclosed are fasteners that include an electrically conductive material and a film-forming composition deposited on at least a portion of the material. The film-forming composition comprises a nitrogen-containing heterocyclic compound. The fasteners are suitable for use with wood that has been treated with a chrome-free copper containing wood preservative. Also disclosed are packages that include a plurality of such fasteners and articles that include a piece of wood in contact with such a fastener.

### FIELD OF THE INVENTION

The present invention is directed to fasteners having a coating deposited thereon, as well as related methods and articles.

### BACKGROUND OF THE INVENTION

Solid wood intended for use in exterior applications is often treated with a wood preservative to protect the wood from deterioration due to exposure to a variety of environmental conditions. Copper chrome arsenate (CCA) is a leach-resistant wood preservative that has been used for many years in such applications. Such preservatives are, however, facing increasing regulatory pressure as a result of environmental, health, and safety problems due to the toxic nature of arsenic and chromium. Therefore, suitable alternative systems have been sought. This has resulted in alternative preservative formulations, such as ammonical copper quat (ACQ) and copper azole (CA). These formulations, unfortunately, have been shown to be more corrosive to fasteners than CCA. As a result, fasteners constructed of hot dip galvanized and/or stainless steel are often required by the building codes for use in pressure treated wood applications in which the wood has been treated with ACQ or CA. Such fasteners, however, are relatively expensive.

Therefore, it would be desirable to provide improved coated fasteners that are resistant to corrosion that results from contact of such fasteners with wood treated with a chrome-free wood preservative, such as ACQ and CA, even under torque or shear conditions. The present invention was developed in view of the foregoing desire.

### SUMMARY OF THE INVENTION

In certain respects, the present invention is directed to fasteners. The fasteners of the present invention are constructed of an electrically conductive material and comprise a film-forming composition deposited on at least a portion of the material, wherein the film-forming composition comprises a nitrogen-containing heterocyclic compound. The fasteners of the present invention are suitable for use with wood that has been treated with a chrome-free copper containing wood preservative.

In other respects, the present invention is directed to a package comprising a plurality of fasteners. The plurality of fasteners are constructed of an electrically conductive material and comprise a film-forming composition deposited on at least a portion of the material, the film-forming composition comprising a nitrogen-containing heterocyclic compound. The fasteners are suitable for use with wood that has been treated with a chrome-free copper containing wood preservative.

In yet other respects, the present invention is directed to an article. The article comprises: (a) a piece of wood that has been treated with a chrome-free copper containing wood preservative, and (b) a fastener in contact with the piece of wood. The fastener is constructed of an electrically conductive material and comprises a film-forming composition deposited on at least a portion of the material, the film-forming composition comprising a nitrogen-containing heterocyclic compound.

### BRIEF DESCRIPTION OF THE DRAWING

FIG. 1 illustrates a fastener in accordance with certain embodiments of the present invention; and

FIGS. 2a-d illustrate coated fasteners produced according to certain of the Examples described herein.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As previously indicated, certain embodiments of the present invention are directed to fasteners. As used herein, the term “fastener” refers to a restraining device that attaches to something or holds something in place. Non-limiting examples of fasteners that are within the scope of the present invention are nuts, bolts, screws, pins, nails, clips, rivets, and buttons, among others.

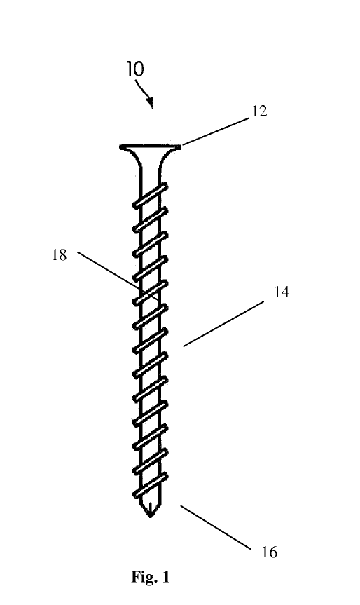

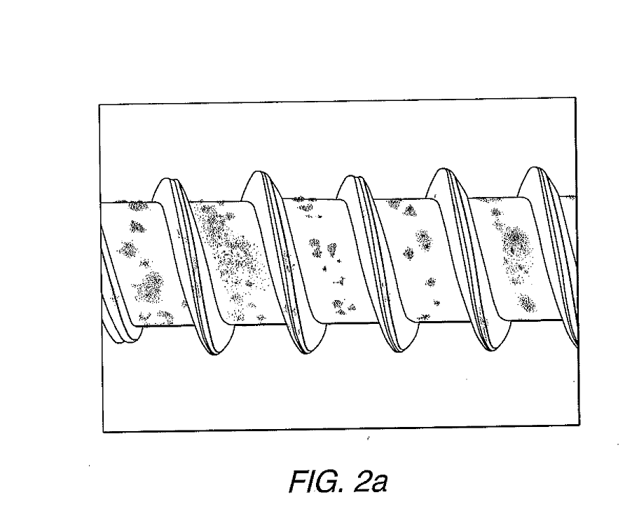

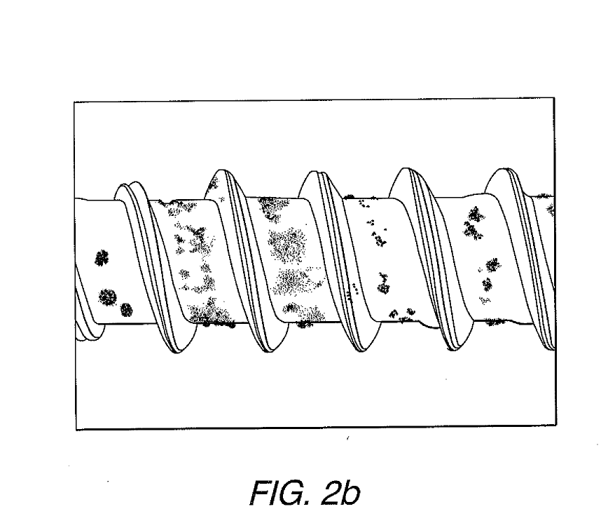

In certain embodiments, as described in more detail below, the fastener of the present invention is a screw suitable for use under torque conditions with wood that has been treated with a chrome-free copper containing preservative. For example, and without limitation, in certain embodiments the fastener comprises a threaded screw, such as is depicted in FIG. 1. As is apparent, in this embodiment, the fastener 10 comprises a head 12 and an elongated shank 14 extending from the bottom portion of the head 12. The elongated shank 14 includes a tip 16 that is opposite the head 12 and which may be of a point or blunt configuration. As is also apparent, the screw also includes a thread 18 that extends along at least a portion of the elongated shank 14. In this embodiment, the thread 18 extends substantially the entire length of the elongated shank 14. In accordance with the present invention, the electrodeposited film-forming composition described herein can be deposited on the entire fastener or any part thereof, such as on all or a portion of the shank described above.

In certain embodiments, the fasteners of the present invention are constructed of an electrically conductive material. Suitable electrically conductive materials include, without limitation, cold rolled steel, hot rolled steel, stainless steel, steel coated with zinc metal, zinc compounds, or zinc alloys, such as electrogalvanized steel, hot-dipped galvanized steel, galvanealed steel, and steel plated with zinc alloy, such as a zinc-nickel alloy. Also, aluminum alloys, aluminum plated steel and aluminum alloy plated steels may be used. Other suitable non-ferrous metals include copper and magnesium, as well as alloys of these materials.

The fastener that is coated in accordance with the present invention may first be cleaned to remove grease, dirt, or other extraneous matter. This is often done by employing mild or strong alkaline cleaners, such as, for example, Chemkleen 163 and Chemkleen 177, both of which are commercially available from PPG Industries, Inc. Such cleaners are often followed and/or preceded by a water rinse.

In certain embodiments, the fastener is rinsed with an aqueous acidic solution after cleaning with an alkaline cleaner. Examples of rinse solutions include mild or strong acidic cleaners, such as dilute nitric acid solutions commercially available and conventionally used in metal pretreatment processes.

The fastener may also be pretreated with, for example, a phosphate conversion, usually a zinc phosphate conversion coating, followed by a rinse which seals the conversion coating.

In some cases, the pre-treatment composition is a solution that comprises one or more Group IIIB or IVB element-containing compounds or mixtures thereof solubilized or dispersed in a carrier medium, typically an aqueous medium. Transition metal compounds and rare earth metal compounds typically are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. In many cases, the Group IIIB or IVB metal compounds are in the form of metal salts or acids which are water soluble. The Group IIIB or IVB metal compound is often present in the carrier medium in an amount of 10 to 5000 ppm metal.

The pretreatment composition carrier also may contain a film-forming resin, such as the reaction product of an alkanolamine and an epoxy-functional material containing at least two epoxy groups, as disclosed in, for example, U.S. Pat. No. 5,653,823. Other suitable resins include water soluble and water dispersible polyacrylic acids such as those as disclosed in U.S. Pat. Nos. 3,912,548 and 5,328,525; phenol-formaldehyde resins as described in U.S. Pat. No. 5,662,746; water soluble polyamides, such as those disclosed in WO 95/33869; copolymers of maleic or acrylic acid with allyl ether as described in Canadian patent application 2,087,352; and water soluble and dispersible resins including epoxy resins, aminoplasts, phenol-formaldehyde resins, tannins, and polyvinyl phenols as discussed in U.S. Pat. No. 5,449,415.

In some cases, the fastener is pretreated with a non-insulating layer of organophosphates or organophosphonates such as is described in U.S. Pat. Nos. 5,294,265 and 5,306,526.

The pretreatment coating composition can further comprise surfactants. Other optional materials in the carrier medium include defoamers and substrate wetting agents.

In some cases, the pretreatment coating composition is essentially free of chromium-containing materials, i.e., the composition contains less than about 2 weight percent of chromium-containing materials (expressed as CrO₃). Examples of such chromium-containing materials include chromic acid, chromium trioxide, chromic acid anhydride, dichromate salts such as ammonium dichromate, sodium dichromate, potassium dichromate, and calcium, barium, magnesium, zinc, cadmium and strontium dichromate.

The thickness of the pretreatment film can vary, but is generally less than 1 micrometer, such as from 1 to 500 nanometers, or, in some cases, from 10 to 300 nanometers.

The pretreatment coating composition may be applied to the fastener by any conventional application technique, such as by spraying, immersion or roll coating in a batch or continuous process. The temperature of the pretreatment coating composition at application is typically 10° C. to 85° C., such as 15° C. to 60° C. The pH of the preferred pretreatment coating composition at application generally ranges from 2.0 to 5.5, such as 3.5 to 5.5. The pH of the medium may be adjusted using mineral acids such as hydrofluoric acid, fluoroboric acid, phosphoric acid, and the like, including mixtures thereof; organic acids such as lactic acid, acetic acid, citric acid, sulfamic acid, or mixtures thereof, and water soluble or water dispersible bases such as sodium hydroxide, ammonium hydroxide, ammonia, or amines such as triethylamine, methylethyl amine, or mixtures thereof.

The film coverage of the residue of the pretreatment composition generally ranges from about 1 to about 10,000 milligrams per square meter (mg/m²).

A layer of a weldable primer also may be applied to the fastener, whether or not the fastener is pretreated. A typical weldable primer is BONAZINC® a zinc-rich mill applied organic film-forming composition, which is commercially available from PPG Industries, Inc., Pittsburgh, Pa. Other weldable primers, such as iron phosphide-rich primers, are commercially available.

In some cases, a zinc-rich primer may be applied to the fastener, whether or not the fastener is pretreated. One suitable zinc-rich primer comprises zinc particles and a film-forming binder that comprising a hybrid organic-inorganic copolymer formed from: (i) a titanate and/or a partial hydrolysate thereof, and (ii) a polyfunctional polymer having functional groups reactive with alkoxy groups of the titanate and/or the partial hydrolysate thereof. Such zinc-rich primer are described in U.S. patent application Ser. Nos. 11/415,582 and 11/610,069, each of which being incorporated herein by reference.

As previously indicated, the fasteners of the present invention comprise a film-forming composition deposited on at least a portion of the electrically conductive material. In certain embodiments, the film-forming composition is an electrodeposited film-forming composition. As used herein, the term “electrodeposited film-forming composition” refers to a film-forming composition deposited from an aqueous dispersion that is placed in contact with an electrically conductive anode and cathode, where the substrate serves as the cathode. Upon passage of an electric current between the anode and cathode while they are in contact with the aqueous dispersion, an adherent film of the composition deposits in a substantially continuous manner on the cathode. The film contains the components from the non-aqueous phase of the dispersion.

In the present invention the electrodeposited film-forming composition comprises an active hydrogen-containing, ionic salt group-containing resin. In certain embodiments, the active hydrogen-containing, ionic salt group-containing resin is a cationic resin, for example such as is typically derived from a polyepoxide and can be prepared by reacting together a polyepoxide and, optionally, a polyhydroxyl group-containing material selected from alcoholic hydroxyl group-containing materials and phenolic hydroxyl group-containing materials to chain extend or build the molecular weight of the polyepoxide. The reaction product can then be reacted with a cationic salt group former to produce the cationic resin.

A chain extended polyepoxide typically is prepared as follows: the polyepoxide and polyhydroxyl group-containing material are reacted together neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction typically is conducted at a temperature of 80° C. to 160° C. for 30 to 180 minutes until an epoxy group-containing resinous reaction product is obtained. The equivalent ratio of reactants; i.e., epoxy:polyhydroxyl group-containing material is often from 1.00:0.50 to 1.00:2.00.

The polyepoxide often has at least two 1,2-epoxy groups. The epoxide equivalent weight of the polyepoxide will often range from 100 to 2000. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency greater than one, such as two; that is, polyepoxides which have on average two epoxide groups per molecule. Polyglycidyl ethers of polyhydric alcohols, such as cyclic polyols, are often used, an example of which are polyglycidyl ethers of polyhydric phenols, such as Bisphenol A. These polyepoxides can be produced by etherification of polyhydric phenols with an epihalohydrin or dihalohydrin such as epichlorohydrin or dichlorohydrin in the presence of alkali. Besides polyhydric phenols, other cyclic polyols can be used in preparing the polyglycidyl ethers of cyclic polyols. Examples of other cyclic polyols include alicyclic polyols, particularly cycloaliphatic polyols such as 1,2-cyclohexane diol and 1,2-bis(hydroxymethyl)cyclohexane. The polyepoxides often have epoxide equivalent weights ranging from 180 to 2000. Epoxy group-containing acrylic polymers can also be used. These polymers often have an epoxy equivalent weight ranging from 750 to 2000.

Examples of polyhydroxyl group-containing materials used to chain extend or increase the molecular weight of the polyepoxide (i.e., through hydroxyl-epoxy reaction) include alcoholic hydroxyl group-containing materials and phenolic hydroxyl group-containing materials. Examples of alcoholic hydroxyl group-containing materials are simple polyols such as neopentyl glycol; polyester polyols such as those described in U.S. Pat. No. 4,148,772; polyether polyols such as those described in U.S. Pat. No. 4,468,307; and urethane diols such as those described in U.S. Pat. No. 4,931,157. Examples of phenolic hydroxyl group-containing materials are polyhydric phenols such as Bisphenol A, phloroglucinol, catechol, and resorcinol. Mixtures of alcoholic hydroxyl group-containing materials and phenolic hydroxyl group-containing materials may also be used.

The resin can contain cationic salt groups, which can be incorporated into the resin molecule as follows: The resinous reaction product prepared as described above is further reacted with a cationic salt group former. By “cationic salt group former” is meant a material which is reactive with epoxy groups and which can be acidified before, during, or after reaction with the epoxy groups to form cationic salt groups. Examples of suitable materials include amines such as primary or secondary amines which can be acidified after reaction with the epoxy groups to form amine salt groups, or tertiary amines which can be acidified prior to reaction with the epoxy groups and which after reaction with the epoxy groups form quaternary ammonium salt groups. Examples of other cationic salt group formers are sulfides which can be mixed with acid prior to reaction with the epoxy groups and form ternary sulfonium salt groups upon subsequent reaction with the epoxy groups.

When amines are used as the cationic salt formers, monoamines typically are employed. Hydroxyl-containing amines are suitable, and polyamines also may be used.

Tertiary and secondary amines are used more often than primary amines because primary amines are polyfunctional with respect to epoxy groups and have a greater tendency to gel the reaction mixture. If polyamines or primary amines are used, consideration should be given to them being used in a substantial stoichiometric excess to the epoxy functionality in the polyepoxide so as to prevent gelation and the excess amine should be removed from the reaction mixture by vacuum stripping or other technique at the end of the reaction. The epoxy may be added to the amine to ensure excess amine.

Examples of hydroxyl-containing amines include, but are not limited to, alkanolamines, dialkanolamines, alkyl alkanolamines, and aralkyl alkanolamines containing from 1 to 18 carbon atoms in each of the alkanol, alkyl and aryl groups. Specific examples include ethanolamine, N-methylethanolamine, diethanolamine, N-phenylethanolamine, N,N-dimethylethanolamine, N-methyldiethanolamine, 3-aminopropyldiethanolamine, and N-(2-hydroxyethyl)-piperazine.

Amines such as mono, di, and trialkylamines and mixed aryl-alkyl amines which do not contain hydroxyl groups or amines substituted with groups other than hydroxyl which do not negatively affect the reaction between the amine and the epoxy may also be used. Specific examples include ethylamine, methylethylamine, triethylamine, N-benzyldimethylamine, dicocoamine, 3-dimethylaminopropylamine, and N,N-dimethylcyclohexylamine.

Mixtures of the above mentioned amines may also be used.

The reaction of a primary and/or secondary amine with the polyepoxide takes place upon mixing of the amine and polyepoxide. The amine may be added to the polyepoxide or vice versa. The reaction can be conducted neat or in the presence of a suitable solvent such as methyl isobutyl ketone, xylene, or 1-methoxy-2-propanol. The reaction is generally exothermic and cooling may be desired. However, heating to a moderate temperature of 50 to 150° C. may be done to hasten the reaction.

The reaction product of the primary and/or secondary amine and the polyepoxide is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof; i.e., an acid of the formula:

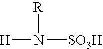

wherein R is hydrogen or an alkyl group having 1 to 4 carbon atoms. Sulfamic acid is preferred. Mixtures of the above mentioned acids may also be used.

The extent of neutralization of the cationic electrodepositable composition varies with the particular reaction product involved. However, sufficient acid should be used to disperse the electrodepositable composition in water. Typically, the amount of acid used provides at least 20 percent of all of the total neutralization. Excess acid may also be used beyond the amount required for 100 percent total neutralization.

In the reaction of a tertiary amine with a polyepoxide, the tertiary amine can be pre-reacted with the neutralizing acid to form the amine salt and then the amine salt reacted with the polyepoxide to form a quaternary salt group-containing resin. The reaction is conducted by mixing the amine salt with the polyepoxide in water. Typically, the water is present in an amount ranging from 1.75 to 20 percent by weight based on total reaction mixture solids.

In forming the quaternary ammonium salt group-containing resin, the reaction temperature can be varied from the lowest temperature at which the reaction will proceed, generally room temperature or slightly thereabove, to a maximum temperature of 100° C. (at atmospheric pressure). At higher pressures, higher reaction temperatures may be used. In some cases, the reaction temperature is in the range of 60 to 100° C. Solvents such as a sterically hindered ester, ether, or sterically hindered ketone may be used, but their use is not necessary.

In addition to the primary, secondary, and tertiary amines disclosed above, a portion of the amine that is reacted with the polyepoxide can be a ketimine of a polyamine, such as is described in U.S. Pat. No. 4,104,147, column 6, line 23 to column 7, line 23. The ketimine groups decompose upon dispersing the amine-epoxy resin reaction product in water. In certain embodiments, at least a portion of the active hydrogens present in the resin (a) comprise primary amine groups derived from the reaction of a ketimine-containing compound and an epoxy group-containing material such as those described above.

In addition to resins containing amine salts and quaternary ammonium salt groups, cationic resins containing ternary sulfonium groups may be used. Examples of these resins and their method of preparation are described in U.S. Pat. Nos. 3,793,278 and 3,959,106.

Suitable active hydrogen-containing, cationic salt group-containing resins can include copolymers of one or more alkyl esters of acrylic acid or methacrylic acid optionally together with one or more other polymerizable ethylenically unsaturated monomers. Suitable alkyl esters of acrylic acid or methacrylic acid include methyl methacrylate, ethyl methacrylate, butyl methacrylate, ethyl acrylate, butyl acrylate, and 2-ethyl hexyl acrylate. Suitable other copolymerizable ethylenically unsaturated monomers include nitriles such acrylonitrile and methacrylonitrile, vinyl and vinylidene halides such as vinyl chloride and vinylidene fluoride and vinyl esters such as vinyl acetate. Acid and anhydride functional ethylenically unsaturated monomers such as acrylic acid, methacrylic acid or anhydride, itaconic acid, maleic acid or anhydride, or fumaric acid may be used. Amide functional monomers including acrylamide, methacrylamide, and N-alkyl substituted (meth)acrylamides are also suitable. Vinyl aromatic compounds such as styrene and vinyl toluene can be used so long as photodegradation resistance of the polymer and the resulting electrodeposited coating is not compromised.

Functional groups such as hydroxyl and amino groups can be incorporated into the acrylic polymer by using functional monomers such as hydroxyalkyl acrylates and methacrylates or aminoalkyl acrylates and methacrylates. Epoxide functional groups (for conversion to cationic salt groups) may be incorporated into the acrylic polymer by using functional monomers such as glycidyl acrylate and methacrylate, 3,4-epoxycyclohexylmethyl(meth)acrylate, 2-(3,4-epoxycyclohexyl)ethyl(meth)acrylate, or allyl glycidyl ether. Alternatively, epoxide functional groups may be incorporated into the acrylic polymer by reacting carboxyl groups on the acrylic polymer with an epihalohydrin or dihalohydrin such as epichlorohydrin or dichlorohydrin.

The acrylic polymer can be prepared by traditional free radical initiated polymerization techniques, such as solution or emulsion polymerization, as known in the art, using suitable catalysts which include organic peroxides and azo type compounds and optionally chain transfer agents such as alpha-methyl styrene dimer and tertiary dodecyl mercaptan. Additional acrylic polymers which are suitable for forming the active hydrogen-containing, cationic resin (a) which can be used in the electrodepositable compositions described herein include those resins described in U.S. Pat. Nos. 3,455,806 and 3,928,157.

Polyurethanes can also be used as the polymer from which the active hydrogen-containing, cationic resin can be derived. Among the polyurethanes which can be used are polymeric polyols which are prepared by reacting polyester polyols or acrylic polyols such as those mentioned above with a polyisocyanate such that the OH/NCO equivalent ratio is greater than 1:1 so that free hydroxyl groups are present in the product. Smaller polyhydric alcohols such as those disclosed above for use in the preparation of the polyester may also be used in place of or in combination with the polymeric polyols.

Additional examples of polyurethane polymers suitable for forming the active hydrogen-containing, cationic resin (a) include the polyurethane, polyurea, and poly(urethane-urea) polymers prepared by reacting polyether polyols and/or polyether polyamines with polyisocyanates. Such polyurethane polymers are described in U.S. Pat. No. 6,248,225.

Epoxide functional groups may be incorporated into the polyurethane by methods well known in the art. For example, epoxide groups can be incorporated by reacting glycidol with free isocyanate groups. Alternatively, hydroxyl groups on the polyurethane can be reacted with an epihalohydrin or dihalohydrin such as epichlorohydrin or dichlorohydrin in the presence of alkali.

Sulfonium group-containing polyurethanes can also be made by at least partial reaction of hydroxy-functional sulfide compounds, such as thiodiglycol and thiodipropanol, which results in incorporation of sulfur into the backbone of the polymer. The sulfur-containing polymer is then reacted with a monofunctional epoxy compound in the presence of acid to form the sulfonium group. Appropriate monofunctional epoxy compounds include ethylene oxide, propylene oxide, glycidol, phenylglycidyl ether, and CARDURA® E, available from Resolution Performance Products.

Besides the above-described polyepoxide, acrylic and polyurethane polymers, the active hydrogen-containing, cationic salt group-containing polymer can be derived from a polyester. Such polyesters can be prepared in a known manner by condensation of polyhydric alcohols and polycarboxylic acids. Suitable polyhydric alcohols include, for example, ethylene glycol, propylene glycol, butylene glycol, 1,6-hexylene glycol, neopentyl glycol, diethylene glycol, glycerol, trimethylol propane, and pentaerythritol. Examples of suitable polycarboxylic acids used to prepare the polyester include succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used.

The polyesters contain a portion of free hydroxyl groups (resulting from the use of excess polyhydric alcohol and/or higher polyols during preparation of the polyester) which are available for cure reactions. Epoxide functional groups may be incorporated into the polyester by reacting carboxyl groups on the polyester with an epihalohydrin or dihalohydrin such as epichlorohydrin or dichlorohydrin.

Sulfonium salt groups can be introduced by the reaction of an epoxy group-containing polymer of the types described above with a sulfide in the presence of an acid, as described in U.S. Pat. Nos. 3,959,106 and 4,715,898. Sulfonium groups can be introduced onto the polyester backbones described using similar reaction conditions.

It should be understood that the active hydrogens associated with the cationic resin include any active hydrogens which are reactive with isocyanates at temperatures sufficient to cure the electrodepositable composition as previously discussed, i.e., at temperatures at or below 360° F. (182.2° C.). The active hydrogens typically are derived from reactive hydroxyl groups, and primary and secondary amino, including mixed groups such as hydroxyl and primary amino. In certain embodiments, at least a portion of the active hydrogens are derived from hydroxyl groups comprising phenolic hydroxyl groups. The cationic resin can have an active hydrogen content of 1 to 4 milliequivalents, typically 2 to 3 milliequivalents of active hydrogen per gram of resin solids.

The extent of cationic salt group formation should be such that when the resin is mixed with an aqueous medium and other ingredients, a stable dispersion of the electrodepositable composition will form. By “stable dispersion” is meant one that does not settle or is easily redispersible if some settling occurs. Moreover, the dispersion should be of sufficient cationic character that the dispersed resin particles will electrodeposit on a cathode when an electrical potential is set up between an anode and a cathode immersed in the aqueous dispersion.

In some cases, the cationic resin in the electrodepositable compositions described herein contains from 0.1 to 3.0, such as from 0.1 to 0.7 milliequivalents of cationic salt group per gram of resin solids. The cationic resin typically is non-gelled, having a number average molecular weight ranging from 2000 to 15,000, preferably from 5000 to 10,000. By “non-gelled” is meant that the resin is substantially free from crosslinking, and prior to cationic salt group formation, the resin has a measurable intrinsic viscosity when dissolved in a suitable solvent. In contrast, a gelled resin, having an essentially infinite molecular weight, would have an intrinsic viscosity too high to measure.

In certain embodiments, the active hydrogen-containing, cationic salt group-containing resin (a) is present in the electrodepositable composition in an amount ranging from 40 to 95 weight percent, typically from 50 to 75 weight percent based on weight of total resin solids present in the composition.

In certain embodiments of the present invention, the film-forming composition also comprises a curing agent for the active hydrogen-containing, ionic salt group-containing resin described above. Suitable curing agents include, for example, polyisocyanates, polyesters and/or carbonates. The polyisocyanate curing agent may be a fully blocked polyisocyanate with substantially no free isocyanate groups, or it may be partially blocked and reacted with the resin backbone as described in U.S. Pat. No. 3,984,299. The polyisocyanate can be an aliphatic or an aromatic polyisocyanate or a mixture of the two. Diisocyanates are preferred, although higher polyisocyanates can be used in place of or in combination with diisocyanates.

Examples of suitable aliphatic diisocyanates are straight chain aliphatic diisocyanates such as 1,4-tetramethylene diisocyanate, norbornane diisocyanate, and 1,6-hexamethylene diisocyanate. Also, cycloaliphatic diisocyanates can be employed. Examples include isophorone diisocyanate and 4,4′-methylene-bis-(cyclohexyl isocyanate). Examples of suitable aromatic diisocyanates are p-phenylene diisocyanate, diphenylmethane-4,4′-diisocyanate and 2,4- or 2,6-toluene diisocyanate. Examples of suitable higher polyisocyanates are triphenylmethane-4,4′,4″-triisocyanate, 1,2,4-benzene triisocyanate and polymethylene polyphenyl isocyanate, and trimers of 1,6-hexamethylene diisocyanate.

Isocyanate prepolymers, for example, reaction products of polyisocyanates with polyols such as neopentyl glycol and trimethylol propane or with polymeric polyols such as polycaprolactone diols and triols (NCO/OH equivalent ratio greater than one) can also be used. A mixture of diphenylmethane-4,4′-diisocyanate and polymethylene polyphenyl isocyanate can be used.

Any suitable alcohol or polyol can be used as a blocking agent for the polyisocyanate in the electrodepositable compositions described herein provided that the agent will deblock at the curing temperature and provided a gelled product is not formed. Any suitable aliphatic, cycloaliphatic, or aromatic alkyl alcohol may be used as a blocking agent for the polyisocyanate including, for example, lower aliphatic monoalcohols such as methanol, ethanol, and n-butanol; cycloaliphatic alcohols such as cyclohexanol; aromatic-alkyl alcohols such as phenyl carbinol and methylphenyl carbinol. Glycol ethers may also be used as blocking agents. Suitable glycol ethers include ethylene glycol butyl ether, diethylene glycol butyl ether, ethylene glycol methyl ether and propylene glycol methyl ether.

In certain embodiments, the blocking agent comprises one or more 1,3-glycols and/or 1,2-glycols. In certain embodiments, the blocking agent comprises one or more 1,2-glycols, typically one or more C₃ to C₆ 1,2-glycols. For example, the blocking agent can be selected from at least one of 1,2-propanediol, 1,3-butanediol, 1,2-butanediol, 1,2-pentanediol and 1,2-hexanediol. It has been observed that the presence of such blocking agents facilitates dissolution or dispersion of the organotin catalyst in the resinous phase or components thereof.

Other suitable blocking agents include oximes such as methyl ethyl ketoxime, acetone oxime and cyclohexanone oxime and lactams such as epsilon-caprolactam.

In certain embodiments, the curing agent comprises one or more polyester curing agents. Suitable polyester curing agents include materials having greater than one ester group per molecule. The ester groups are present in an amount sufficient to effect cross-linking at acceptable cure temperatures and cure times, for example at temperatures up to 250° C., and curing times of up to 90 minutes. It should be understood that acceptable cure temperatures and cure times will be dependent upon the substrates to be coated and their end uses.

Compounds generally suitable as the polyester curing agent are polyesters of polycarboxylic acids. Non-limiting examples include bis(2-hydroxyalkyl)esters of dicarboxylic acids, such as bis(2-hydroxybutyl)azelate and bis(2-hydroxyethyl)terephthalate; tri(2-ethylhexanoyl)trimellitate; and poly(2-hydroxyalkyl)esters of acidic half-esters prepared from a dicarboxylic acid anhydride and an alcohol, including polyhydric alcohols. The latter type is suitable to provide a polyester with a final functionality of more than 2. One suitable example includes a polyester prepared by first reacting equivalent amounts of the dicarboxylic acid anhydride (for example, succinic anhydride or phthalic anhydride) with a trihydric or tetrahydric alcohol, such as glycerol, trimethylolpropane or pentaerythritol, at temperatures below 150° C., and then reacting the acidic polyester with at least an equivalent amount of an epoxy alkane, such as 1,2-epoxy butane, ethylene oxide, or propylene oxide. The polyester curing agent (ii) can comprise an anhydride. Another suitable polyester comprises a lower 2-hydroxy-alkylterminated poly-alkyleneglycol terephthalate.

In certain embodiments, the polyester comprises one or more ester groups per molecule in which the carbon atom adjacent to the esterified hydroxyl has a free hydroxyl.

Also suitable is the tetrafunctional polyester prepared from the half-ester intermediate prepared by reacting trimellitic anhydride and propylene glycol (molar ratio 2:1), then reacting the intermediate with 1,2-epoxy butane and the glycidyl ester of branched monocarboxylic acids.

In certain embodiments, where the active hydrogen-containing resin comprises cationic salt groups, the polyester curing agent is substantially free of acid. For purposes of the present invention, by “substantially free of acid” is meant having less than 0.2 meq/g acid. For aqueous systems, for example for cathodic electrodepositable, coating compositions, suitable polyester curing agents can include non-acidic polyesters prepared from a polycarboxylic acid anhydride, one or more glycols, alcohols, glycol mono-ethers, polyols, and/or monoepoxides.

Suitable polycarboxylic anhydrides can include dicarboxylic acid anhydrides, such as succinic anhydride, phthalic anhydride, tetrahydrophthalic anhydride, trimellitic anhydride, hexahydrophthalic anhydride, methylhexahydrophthalic anhydride, 3,3′,4,4′-benzophenonetetracarboxylic dianhydride, and pyromellitic dianhydride. Mixtures of anhydrides can be used.

Suitable alcohols can include linear, cyclic or branched alcohols. The alcohols may be aliphatic, aromatic or araliphatic in nature. As used herein, the terms glycols and mono-epoxides are intended to include compounds containing not more than two alcohol groups per molecule which can be reacted with carboxylic acid or anhydride functions below the temperature of 150° C.

Suitable mono-epoxides can include glycidyl esters of branched monocarboxylic acids. Further, alkylene oxides, such as ethylene oxide or propylene oxide may be used. Suitable glycols can include, for example ethylene glycol and polyethylene glycols, propylene glycol and polypropylene glycols, and 1,6-hexanediol. Mixtures of glycols may be used.

Non-acidic polyesters can be prepared, for example, by reacting, in one or more steps, trimellitic anhydride (TMA) with glycidyl esters of branched monocarboxylic acids in a molar ratio of 1:1.5 to 1:3, if desired with the aid of an esterification catalyst such as stannous octoate or benzyl dimethyl amine, at temperatures of 50-150° C. Additionally, trimellitic anhydride can be reacted with 3 molar equivalents of a monoalcohol such as 2-ethylhexanol.

Alternatively, trimellitic anhydride (1 mol.) can be reacted first with a glycol or a glycol monoalkyl ether, such as ethylene glycol monobutyl ether in a molar ratio of 1:0.5 to 1:1, after which the product is allowed to react with 2 moles of glycidyl esters of branched monocarboxylic acids. Furthermore, the polycarboxylic acid anhydride i.e., those containing two or three carboxyl functions per molecule) or a mixture of polycarboxylic acid anhydrides can be reacted simultaneously with a glycol, such as 1,6-hexane diol and/or glycol mono-ether and monoepoxide, after which the product can be reacted with mono-epoxides, if desired. For aqueous compositions these non-acid polyesters can also be modified with polyamines such as diethylene triamine to form amide polyesters. Such “amine-modified” polyesters may be incorporated in the linear or branched amine adducts described above to form self-curing amine adduct esters.

The non-acidic polyesters of the types described above typically are soluble in organic solvents, and typically can be mixed readily with the active hydrogen-containing resin (i) previously described.

Polyesters suitable for use in an aqueous system or mixtures of such materials disperse in water typically in the presence of resins comprising cationic or anionic salt groups.

In certain embodiments, the curing agent comprises one or more cyclic or acyclic carbonates. Non-limiting examples of suitable acyclic carbonates include dimethyl carbonate, diethyl carbonate, methylethyl carbonate, dipropyl carbonate, methylpropyl carbonate, and/or dibutyl carbonate. In some embodiments of the present invention, the acyclic carbonate comprises dimethyl carbonate.

In certain embodiments, the curing agent is present in the film-forming composition in an amount ranging from 5 to 60 percent by weight, such as from 25 to 50 percent by weight based on total weight of resin solids.

As previously indicated, in the present invention, the film-forming composition comprises a nitrogen-containing heterocyclic compound. Examples of such compounds, which are suitable for use in the present invention, are azoles, oxazoles, thiazoles, thiazolines, imidazoles, diazoles, pyridines, indolizines, and triazines, tetrazoles, and tolutriazole, including mixtures of two or more thereof.

In certain embodiments of the present invention, the nitrogen-containing heterocyclic compound included in the film-forming composition comprises a triazole and/or a derivative thereof. Suitable triazoles include, for example, 1,2,3-triazole, 1,2,4-triazole, benzotriazole, and their derivatives. Derivatives of 1,2,3-triazole, which are suitable for use in the present invention, include 1-methyl-1,2,3-triazole, 1-phenyl-1,2,3-triazole, 4-methyl-2-phenyl-1,2,3-triazole, 1-benzyl-1,2,3-triazole, 4-hydroxy-1,2,3-triazole, 1-amino-1,2,3-triazole, 1-benzamido-4-methyl-1,2,3-triazole, 1-amino-4,5-diphenyl-1,2,3-triazole, 1,2,3-triazole aldehyde, 2-methyl-1,2,3-triazole-4-carboxylic acid, and 4-cyano-1,2,3-triazole. Derivatives of 1,2,4-triazole, which are suitable for use in the present invention, include 1-methyl-1,2,4-triazole, 1,3-diphenyl-1,2,4-triazole, 5-amino-3-methyl-1,2,4-triazole, 3-mercapto-1,2,4-triazole, 1,2,4-triazole-3-carboxylic acid, 1-phenyl-1,2,4-triazole-5-one, and 1-phenylurazole. Derivatives of benzotriazole, which are suitable for use in the present invention, include 1-methylbenzotriazole, 5,6-dimethylbenzotriazole, 2-phenylbenzotriazole, 1-hydroxybenzotriazole, methyl 1-benzotriazolecarboxylate, and 2-(3′,5′-dibutyl-2′-hydroxyphenyl)benzotriazole.

In certain embodiments, the nitrogen-containing heterocyclic compound, such as the triazole and/or derivative thereof, is present in the film-forming composition in an amount of at least 0.1 percent by weight, such as at least 0.5 percent by weight, or, in some cases, at least 1 percent by weight, based on total weight of resin solids. In certain embodiments, the nitrogen-containing heterocyclic compound, such as the triazole and/or derivative thereof, is present in the film-forming composition in an amount of no more than 10 percent by weight, such as no more than 5 percent by weight, or, in some cases, no more than 3 percent by weight, based on total weight of resin solids.

While it is known that nitrogen-containing heterocyclic compounds, such as triazoles of the type described above, can, in at least some cases, provide a coating with improved corrosion resistance performance, it was surprisingly discovered that the inclusion of such a material in the film-forming compositions described herein greatly improved, and resulted in a more consistent level of, the adhesion of the film-forming composition to the fastener to such an extent that the resulting coated fastener, even when constructed of a relatively non-corrosion resistant steel, such as cold rolled steel, can be suitable for use under torque conditions or shear conditions with wood that has been treated with a chrome-free copper containing wood preservative, such as ACQ or CA, which are known to be more corrosive to fasteners due to the high copper level. Indeed, as will be appreciated, the effectiveness of a coating in preventing corrosion is dependent upon the ability of the coating to remain intact on the fastener under these conditions. The improved and more consistent adhesion of the coating to the fastener according to the present invention is believed to make the use of less expensive fastener materials of construction viable in such applications.

As used herein, the phrase “suitable for use with wood that has been treated with a chrome-free copper containing wood preservative” means that the fastener is suitable for use in contact with wood that has been treated with a chrome-free copper containing wood preservative, such as ACQ or CA, and is resistant to corrosion at an acceptable and relatively consistent level.

As used herein, the phrase “torque conditions” refers to the torque required to rotate the fastener, such as a screw or bolt, into the wood to an extent sufficient to insert the fastener into the wood such that the fastener can function as intended. As used herein, the phrase “shear conditions” refers to the force applied that is collinear with the fastener and which is required to be applied to the fastener, such as a nail or brad, to insert fastener into the wood such that the fastener can function as intended.

The film-forming composition may optionally contain a coalescing solvent such as hydrocarbons, alcohols, esters, ethers and ketones. Examples of preferred coalescing solvents are alcohols, including polyols, such as isopropanol, butanol, 2-ethylhexanol, ethylene glycol and propylene glycol; ethers such as the monobutyl and monohexyl ethers of ethylene glycol; and ketones such as methyl isobutyl ketone and isophorone. The coalescing solvent is usually present in an amount up to 40 percent by weight, typically ranging from 0.05 to 25 percent by weight based on total weight of the electrodepositable composition.

The film-forming composition may further contain various other optional additives such as plasticizers, surfactants, wetting agents, defoamers, and anti-cratering agents, as well as adjuvant resinous materials different from the resin and the curing agent described above.

In certain embodiments, the film-forming composition comprises a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

As previously indicated, in certain embodiments, the film-forming composition is used in an electrodeposition process in the form of an aqueous dispersion. By “dispersion” is meant a two-phase transparent, translucent, or opaque aqueous resinous system in which the resin, pigment, and water insoluble materials are in the dispersed phase while water and water-soluble materials comprise the continuous phase. The dispersed phase can have an average particle size of less than 10 microns, and can be less than 5 microns. The aqueous dispersion can contain at least 0.05 and usually 0.05 to 50 percent by weight resin solids, depending on the particular end use of the dispersion.

The electrodepositable compositions described herein in the form of an aqueous dispersion have excellent storage stability, that is, upon storage at a temperature of 140° F. (60° C.) for a period of 14 days, the compositions are stable. By “stable dispersion” is meant herein that the resinous phase and the nanoparticulate catalyst remain uniformly dispersed throughout the aqueous phase of the composition. Upon storage under the conditions described above, the dispersions do not flocculate or form a hard sediment. If over time some sedimentation occurs, it can be easily re-dispersed with low shear stirring.

The thickness of the electrodepositable coating applied to the substrate can vary based upon such factors as the type of substrate and intended use of the substrate, i.e., the environment in which the substrate is to be placed and the nature of the contacting materials.

Electrodeposition is usually carried out at a constant voltage in the range of from 1 volt to several thousand volts, typically between 50 and 500 volts. Current density is usually between 1.0 ampere and 15 amperes per square foot (10.8 to 161.5 amperes per square meter) and tends to decrease quickly during the electrodeposition process, indicating formation of a continuous self-insulating film.

After deposition, the coating is heated to cure the deposited composition. The heating or curing operation can be carried out at a temperature in the range of from 250 to 400° F. (121.1 to 204.4° C.), typically from 300 to 360° F. (148.8 to 182.2° C.) for a period of time ranging from 1 to 60 minutes. The thickness of the resultant film typically can range from 10 to 50 microns.

As should be appreciated from the foregoing description, the present invention is also directed to a package comprising a plurality of fasteners. The plurality of fasteners are constructed of an electrically conductive material and comprise a film-forming composition deposited on at least a portion of the material, wherein the film-forming composition comprising a nitrogen-containing heterocyclic compound and wherein the fasteners are suitable for use with wood that has been treated with a chrome-free copper containing wood preservative.

As should also be appreciated from the foregoing description, the present invention is also directed to an article comprising: (a) a piece of wood that has been treated with a chrome-free copper containing wood preservative, and (b) a fastener in contact with the piece of wood. The fastener is constructed of an electrically conductive material and comprises a film-forming composition deposited on at least a portion of the material, the film-forming composition comprising a nitrogen-containing heterocyclic compound.

Illustrating the invention are the following examples, which, however, are not to be considered as limiting the invention to their details. Unless otherwise indicated, all parts and percentages in the following examples, as well as throughout the specification, are by weight.

### EXAMPLES

### Example I

| INGREDIENTS | PARTS BY WEIGHT |
|---|---|
| Cationic Resin¹ | 1005.0 |
| Pigment Paste² | 346.2 |
| Deionized Water | 2453.0 |

¹A cationic resin commercially available as E6250C from PPG Industries.
²A pigment paste commercially available as CP443A from PPG Industries.

The cationic resin was added to a gallon container and gently agitated. The pigment paste was diluted with 100 grams of deionized water and added to the above resin. The remainder of the deionized water was then added to the resin mixture under agitation. Final bath solids were about 15%, with a pigment to resin ratio of 0.25:1.0. Twenty percent of the total bath was removed by ultrafiltration and replaced with deionized water. The resulting paint bath had a pH of 6.18 as measured with an ACCUMET pH meter commercially available from Fisher Scientific; and a conductivity of 994 Ω⁻¹ as measured with a conductivity meter commercially available from YSI, Inc.

The coating composition was deposited onto 2½ or 3 inches zinc nickel plated steel fasteners. This was done by heating the coating composition to 35° C. and then impressing 225 volts between an aluminum wire mesh basket containing 20 fasteners and a stainless steel anode for 30 seconds. After coating cycle is completed the basket was lifted from the coating composition, gently shaken and then submerged back into the coating composition. 225 volts was then applied again for an additional 30 seconds. The basket of coated fasteners was cured in a Despatch PR series cabinet gas oven for 20 minutes at 177° C. or 20 minutes at 191° C. to produce an average film thickness of 1.0 mil.

### Example II

| INGREDIENTS | PARTS BY WEIGHT |
|---|---|
| Cationic Resin³ | 1001.0 |
| Cobratec 99⁴ | 5.7 |
| Propylene glycol monomethyl ether | 10 |
| Pigment Paste⁵ | 342.9 |
| Deionized Water | 2456.2 |

³A resin commercially available as E6250C from PPG Industries.
⁴A Benzotriazole commercially available from PMC Specialties Group.
⁵A pigment paste commercially available as CP443A from PPG Industries.

Cationic resin was added to gallon container and gently agitated. The Cobratec 99 and propylene glycol monomethyl ether were combined in separate container and mixed until the Cobratec 99 was dissolved. This mixture was then added to the cationic resin. The pigment paste was diluted with 100 grams of deionized water and added to the above resin. The remainder of the deionized water was then added to the resin mixture under agitation. Final bath solids were about 15%, with a pigment to resin ratio of 0.25:1.0. Twenty percent of the total bath was removed by ultrafiltration and replaced with deionized water. The resulting bath had a pH of 5.87 as measured with an ACCUMET pH meter commercially available from Fisher Scientific; and a conductivity of 942 Ω⁻¹ as measured with a conductivity meter commercially available from YSI, Inc.

The coating composition was deposited onto 2½ or 3 inches zinc nickel plated steel fasteners. This was done by heating the coating composition to 35° C. and then impressing 225 volts between an aluminum wire mesh basket containing 20 fasteners and a stainless steel anode for 30 seconds. After coating cycle is completed the basket was lifted from the coating composition, gently shaken and then submerged back into the coating composition. 225 volts was then applied again for an additional 30 seconds. The basket of coated fasteners was cured in a Despatch PR series cabinet gas oven for 20 minutes at 177° C. or 20 minutes at 191° C. to produce an average film thickness of 1.0 mil.

### Test Methods:

### Thread Adhesion Test

Commercially available non pressure treated structural framing boards in 2″×4″ widths were cut into pieces 15 inches in length. Test boards were placed into a table top vice in such a manner that the fastener could be driven into the thickest part of the board. Using a Craftsman 19.2 volt ½″ cordless drill—driver model number 315.114480 the fastener was driven into the test board via the forward function of the drill and then the drill was switched to the reverse function so that the fastener was immediately removed from the board. The fastener was then evaluated for loss of coating on the threads.

Results of thread adhesion testing: Each fastener had a total of 14 threads. The number of threads where coating was removed was counted and recorded below. Lower values reflect better adhesion. As is apparent, the fasteners of Example II, which are within the present invention, had reduced and consistent thread losses with the range of 3-4 threads, whereas the fasteners of Example I, outside the scope of the present invention, had a greater amount and greater variability in thread loss, ranging from 2-5 threads.

| | Bake | | | Fastener | Fastener |
|---|---|---|---|---|---|
| Sample | Temp ° F. | Fastener #1 | Fastener #2 | #3 | #4 |
| Example I | 350 | 5 | 3 | 4 | 5 |
| Example II | 350 | 4 | 3 | 4 | 4 |
| Example I | 375 | 4 | 3 | 2 | 4 |
| Example II | 375 | 3 | 4 | 3 | 3 |

### Salt Soak Test

Commercially available CA or ACQ pressure treated 2″×4″ boards were cut into pieces 15 inches in length. Using a Dewalt 3¼″ heavy duty planer model DW680 the boards were planed down ¼ inch on each side of the board. The planed shavings were collected into a common container for each type of pressure treatment. The shavings were mixed in their containers thoroughly before preparation of soak test. Using a 4 ounce jar add 2.8 grams of wood shavings (CA or ACQ) and 62.0 grams of 5% sodium chloride solution. Insert four of the same type of coated fastener into the mixture of wood shavings and 5% sodium chloride such that the threads are submerged into the solution. Attach lid and place test jar into 120° F. hot room. Fasteners were tested for a total of 14 days with observations taken on day 1, day 2, day 4, day 9 and day 14.

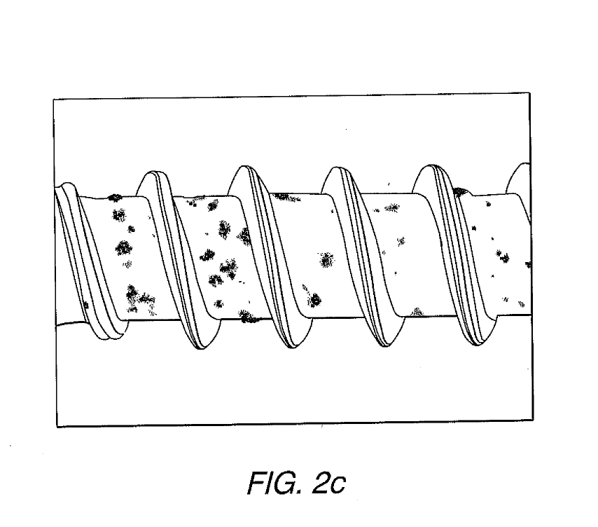

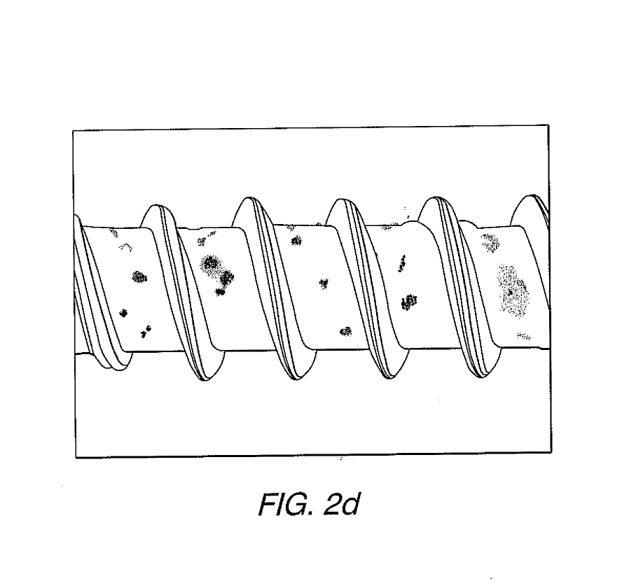

### Results of Salt Soak Testing:

| | Bake | |
|---|---|---|
| Sample | Temp ° F. | Observations after 14 days of exposure |
| Example I | 350 | Significant amount of corrosion present on and |
| | | in between all exposed threads. See FIG. 2a. |
| Example I | 375 | Significant amount of corrosion present in |
| | | between all exposed threads. See FIG. 2b. |
| Example II | 350 | Some corrosion present in between |
| | | threads - small spots. |
| | | See FIG. 2c. |
| Example II | 375 | Some corrosion present in between |
| | | threads - small spots. |
| | | See FIG. 2d. |

As is apparent from FIGS. 2a to 2d, the overall a significantly lower amount of corrosion is present on the fasteners from Example II vs. Example I.

Whereas particular embodiments of this invention have been described above for purposes of illustration, it will be evident to those skilled in the art that numerous variations of the details of the present invention may be made without departing from the invention as defined in the appended claims.

We claim:

1. A fastener constructed of an electrically conductive material and comprising a film-forming composition deposited on at least a portion of the material, wherein:
(a) the film-forming composition comprises a nitrogen-containing heterocyclic compound, and
(b) the fastener is suitable for use with wood that has been treated with a chrome-free copper containing wood preservative.

2. The fastener of claim 1, wherein the film-forming composition is an electrodeposited film-forming composition further comprising:
(a) an active hydrogen-containing, ionic salt group-containing resin; and
(b) a curing agent for (a).

3. The fastener of claim 1, wherein the fastener is suitable for use under torque or shear conditions with wood that has been treated with a chrome-free copper containing wood preservative.

4. The fastener of claim 1, wherein the fastener is selected from the group consisting of a nut, a bolt, a screw, a pin, a nail, a clip, a rivet, and a button.

5. The fastener of claim 1, wherein the material comprises steel.

6. The fastener of claim 5, wherein the steel comprises cold rolled steel or hot rolled steel.

7. The fastener of claim 2, wherein the active hydrogen-containing, ionic salt group-containing resin is a cationic resin.

8. The fastener of claim 1, wherein the nitrogen-containing heterocyclic compound comprises a triazole and/or a derivative thereof.

9. The fastener of claim 7, wherein the triazole and/or a derivative thereof comprises benzotriazole or a derivative thereof.

10. The fastener of claim 1, wherein the nitrogen-containing heterocyclic compound is present in the film-forming composition in an amount ranging from 0.1 to 10 percent by weight based on total weight of resin solids.

11. A package comprising a plurality of the fasteners of claim 1.

12. An article comprising:
(a) a piece of wood that has been treated with a chrome-free copper containing wood preservative, and
(b) a fastener in contact with the piece of wood, wherein the fastener is constructed of an electrically conductive material and comprises a film-forming composition deposited on at least a portion of the material, wherein
the film-forming composition comprises a nitrogen-containing heterocyclic compound.

13. The article of claim 12, wherein the film-forming composition is an electrodeposited film-forming composition further comprising:
(i) an active hydrogen-containing, ionic salt group-containing resin; and
(ii) a curing agent for (i).

14. The article of claim 12, wherein the fastener is in contact with the piece of wood under torque or shear conditions.

15. The article of claim 12, wherein the fastener is selected from the group consisting of a nut, a bolt, a screw, a pin, a nail, a clip, a rivet, and a button.

16. The article of claim 12, wherein the material comprises steel.

17. The article of claim 16, wherein the steel comprises cold rolled steel or hot rolled steel.

18. The article of claim 13, wherein the active hydrogen-containing, ionic salt group-containing resin is a cationic resin.

19. The article of claim 12, wherein the nitrogen-containing heterocyclic compound comprises a triazole and/or a derivative thereof.

20. The article of claim 19, wherein the triazole and/or a derivative thereof comprises benzotriazole or a derivative thereof.
